(19) United States
(12) Patent Application Publication
(10) Pub. No.: US 2021/0266311 A1
(43) Pub. Date: Aug. 26, 2021

(54) BLOCKCHAIN AND DNSSEC-BASED USER AUTHENTICATION METHOD, SYSTEM, DEVICE AND MEDIUM

(71) Applicant: CHINA INTERNET NETWORK INFORMATION CENTER, Beijing (CN)

(72) Inventors: Yu ZENG, Beijing (CN); Yuedong ZHANG, Beijing (CN); Peng ZUO, Beijing (CN); Meng YUAN, Beijing (CN); Haikuo ZHANG, Beijing (CN); Weiping YANG, Beijing (CN)

(21) Appl. No.: 17/253,059

(22) PCT Filed: Feb. 28, 2019
(86) PCT No.: PCT/CN2019/076467

§ 371 Date: Dec. 16, 2020

(30) Foreign Application Priority Data
Feb. 20, 2019 (CN) 201910126525.2

(51) Int. Cl. H04L 29/06; H04L 9/06

(52) U.S. Cl. CPC H04L 63/0823; H04L 9/0637

(57) ABSTRACT

Provided in the present application are a blockchain and DNSSEC-based user authentication method, a system, a device, and a medium, the method comprising: when an encrypted connection over Internet need to be performed between a server and a client, authenticating, by the server, the identity of the client by means of a blockchain-based authentication mechanism, and authenticating, by the client, the identity of the server by means of a DNSSEC-based mechanism. According to the blockchain and DNSSEC-based user authentication method provided in the present application, mutual authentication for an encrypted connection process over Internet is achieved by means of blockchain and DNSSEC-based validation mechanisms without relying on CA authentication. Thus, there are no problems of CA single point of failure or multi-CA mutual trust risk. In addition, the blockchain and DNSSEC-based user authentication method according to the present application is relatively convenient to be implemented.

### CROSS-REFERENCE TO RELATED APPLICATION

The present application claims priority to Chinese Application No. 2019101265252 filed on Feb. 20, 2019, entitled “Blockchain and DNSSEC-Based User Authentication Method, System, Device and Medium,” which is incorporated herein by reference in its entirety.

### FIELD OF TECHNOLOGY

The present application relates to the technical field of computer, and more particularly, to a blockchain and DNSSEC-based user authentication method, a system, a device and a medium.

### BACKGROUND

Identity authentication, access control, and privacy protection are important issues in the field of information security. With the rapid development of the Internet, the complexity of user authentication methods has gradually increased.

The traditional identity authentication technology for encrypted connections over Internet is mainly implemented by means of a distributed PKI-based authentication system. User's identity is managed based on a trusted third-party authentication server, and is confirmed by the user's knowledge (such as the user's password), possession (such as data certificates, identity tokens), as well as biometrics (such as fingerprints and iris), thus this technology has a great dependence on third-party credibility. The untrusted problem of CA will lead to the untrustworthiness of entity identity, and an attack on a CA or the issuance of a certificate by a malicious CA will bring major security risks to the information system. Hackers can perform malicious activities s by attacking the CA trusted by the user and issue a user certificate containing false information, thereby enabling man-in-the-middle attacks. At the same time, the current CA mainly implements the issuance of server certificates. During the encrypted connection process, only the user can authenticate the server, but the server cannot authenticate the user.

In summary, the current user authentication mainly has the following problems: a. it is difficult to provide two-way authentication; b. it has a great dependence on CA, with the problems of CA single point of failure and multi-CA mutual trust risk; c. it has a high implementation cost.

### SUMMARY

In order to address at least the problems of the prior art, the present application provides a blockchain and DNSSEC-based user authentication method, a system, a device and a medium.

Specifically, the present application provides the following technical solutions.

According to a first aspect, the present application provides a blockchain and DNSSEC-based user authentication method, including:

when an encrypted connection over Internet need to be performed between a server and a client, authenticating, by the server, the identity of the client by means of a blockchain-based authentication mechanism, and authenticating, by the client, the identity of the server by means of a DNSSEC-based mechanism.

In an embodiment, the authenticating, by the server, the identity of the client by means of a blockchain-based authentication mechanism includes:

authenticating, by the server, the identity of the client according to a blockchain-based certificate system.

In an embodiment, the authenticating, by the server, the identity of the client according to a blockchain-based certificate system includes:

searching for, by the server, whether a corresponding personal certificate is present in the blockchain-based certificate system according to user information, and indicating that the identity authentication is successful when the corresponding personal certificate is present.

In an embodiment, the method further includes: before the authenticating, by the server, the identity of the client according to a blockchain-based certificate system,

establishing a blockchain-based certificate system, generating a personal certificate for each legitimate user, and issuing and storing the personal certificate by means of the blockchain-based certificate system.

In an embodiment, the authenticating, by the client, the identity of the server by means of a DNSSEC-based mechanism comprises:

validating, by the client, a server certificate by means of DNSSEC to authenticate the identity of the server.

In an embodiment, the validating, by the client, a server certificate by means of DNSSEC to authenticate the identity of the server comprises:

searching for, by the client, a TLSA record corresponding to the server, and performing DNSSEC validation, indicating that the identity authentication is successful when the DNSSEC validation passes.

In an embodiment, the method further includes before the validating, by the client, a server certificate by means of DNSSEC to authenticate the identity of the server,

implementing DNSSEC for the domain name of the server; and

generating a server certificate for the server, and generating a corresponding TLSA record according to the server certificate, the TLSA record including the server certificate.

According to a second aspect, the present application further provides a blockchain and DNSSEC-based user authentication system, including: a client and a server in which

the server is configured to authenticate the identity of the client by means of a blockchain-based authentication mechanism; and

the client is configured to authenticate the identity of the server by means of a DNS SEC-based mechanism.

According to a third aspect, the present application further provides an electronic device, including: a memory, a processor, and a computer program stored in the memory and executable by the processor, wherein the processor is configured to execute the program to process the steps of the blockchain and DNSSEC-based user authentication method of the first aspect.

According to a fourth aspect, the present application further provides a computer readable storage medium in which a computer program is stored, wherein the computer programs are executable by the processor to implement the steps of the blockchain and DNS SEC-based user authentication method of the first aspect.

According to the technical solutions above, the blockchain and DNSSEC-based user authentication method in the present application includes: when an encrypted connection over Internet need to be performed between a server and a client, authenticating, by the server, the identity of the client by means of a blockchain-based authentication mechanism, and authenticating, by the client, the identity of the server by means of a DNSSEC-based mechanism. In the blockchain and DNSSEC-based user authentication method according to the present application, two-way authentication for an encrypted connection process over Internet is achieved by means of blockchain and DNSSEC-based validation mechanisms without relying on CA authentication. Thus, there are no problems of CA single point of failure or multi-CA mutual trust risk. In addition, the blockchain and DNSSEC-based user authentication method according to the present application is relatively convenient to be implemented.

### BRIEF DESCRIPTION OF THE DRAWINGS

In order to illustrate the embodiments of the present application or the technical solutions in the prior art, drawings needed in the embodiments or the description of the prior art is briefly introduced as follows. Obviously, the drawings in the following description are only some of the embodiments of the present application. For those of ordinary skill in the art, other modifications can be obtained based on these drawings without paying any creative effort.

FIG. 1 is a flowchart of a blockchain and DNSSEC-based user authentication method according to an embodiment of the present application;

FIG. 2 is an interactive flowchart of a blockchain and DNSSEC-based user authentication method according to an embodiment of the present application;

FIG. 3 is a schematic structural diagram of a blockchain and DNSSEC-based user authentication method according to another embodiment of the present application; and

FIG. 4 is a schematic structural diagram of an electronic device according to yet another embodiment of the present application.

### DETAILED DESCRIPTION

In order to specify the objectives, technical solutions and advantages of the embodiments of the present application, the technical solutions in the embodiments of the present application will be described clearly and completely in conjunction with the accompanying drawings in the embodiments of the present application. Obviously, the embodiments described below are part of the embodiments of the present application, rather than all of the embodiments. Based on the embodiments in the present application, all other embodiments obtained by those of ordinary skill in the art without creative effort shall fall within the protection scope of the present application.

The present application provides a blockchain and DNSSEC-based user authentication method, a system, a device, and a medium. The content of the present application will be explained in detail below by way of specific embodiments.

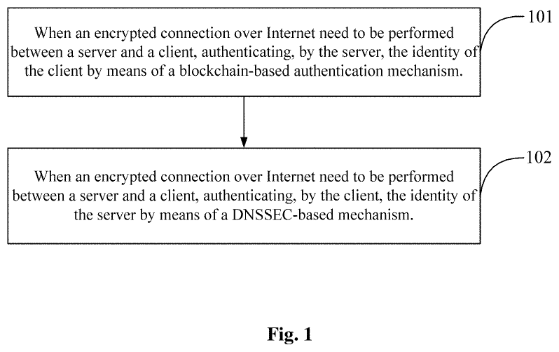

FIG. 1 is a flowchart of a blockchain and DNSSEC-based user authentication method according to an embodiment of the present application. As shown in FIG. 1, the blockchain and DNSSEC-based user authentication method according to the embodiment of the present application includes the following steps:

Step 101: when an encrypted connection over the Internet need to be performed between a server and a client, authenticating, by the server, the identity of the client by means of a blockchain-based authentication mechanism.

In this step, it should be noted that since blockchain technology is a decentralized, de-trusted, open and transparent distributed data storage technology, reliable authentication of user identity can be achieved through a blockchain-based authentication mechanism, while the authentication cost is lower and the authentication process is more convenient. Therefore, in this step, when an encrypted connection over Internet need to be performed between the server and the client, the server authenticates the identity of the client by means of a blockchain-based authentication mechanism. For example, the server may search for whether a corresponding personal certificate is present in the blockchain-based certificate system according to user information, and the personal certificate indicates that the identity authentication is successful when the corresponding personal certificate is present. With regard to blockchain validation, one is client source validation, equivalent to anonymous one, which only verifies the validity; the other is personal identity validation, which must be combined with some offline reviews, and identity validation should be made during the review.

Step 102: when an encrypted connection over the Internet need to be performed between a server and a client, authenticating, by the client, the identity of the server by means of a DNSSEC-based mechanism.

In this step, DNSSEC (Domain Name System Security Extensions) is a security extension to the DNS protocol and is a series of mechanisms for DNS security authentication provided by the IETF. It provides source identification and an extension to data integrity. Since the server generally provides the service address through a domain name, the domain name related features of the server itself can be taken full advantage for server authentication during the identity authentication using DNSSEC.

In this embodiment, the server may be a bank, a company, or a chain of alliances formed by multiple banking companies, or the like; the client may be a bank customer, a company employee, or the like. The server and the client may also be other service-side users and client-side users, such as service-side users and client-side users of other secure transaction platforms, that need to make an encrypted connection over the Internet, which is not limited in the present application.

It should be noted that in this embodiment, the blockchain-based client authentication mechanism and the DNSSEC-based server authentication mechanism provides not only the two-way authentication of the server and the client without relying on CA, but also reduces the cost of building and maintaining a complex domain name system, lowers the cost of trust, and achieves reliable data interaction for enterprises.

According to the technical solutions above, the blockchain and DNSSEC-based user authentication method of this embodiment includes: when an encrypted connection over the Internet need to be performed between a server and a client, authenticating, by the server, the identity of the client by means of a blockchain-based authentication mechanism, and authenticating, by the client, the identity of the server by means of a DNSSEC-based mechanism. According to the blockchain and DNSSEC-based user authentication method of this embodiment, two-way authentication for an encrypted connection process over Internet is achieved by means of blockchain and DNSSEC-based validation mechanisms without relying on CA authentication. Thus, there are no problems of CA single point of failure or multi-CA mutual trust risk. In addition, the blockchain and DNSSEC-based user authentication method provided in this embodiment is relatively convenient to be implemented.

On the basis of the content of the foregoing embodiment, in an alternative embodiment, the foregoing step 101 may be implemented in the following manner

when an encrypted connection over the Internet need to be performed between a server and a client, authenticating, by the server, the identity of the client according to a blockchain-based certificate system.

In this embodiment, a blockchain-based certificate system is established firstly, a personal certificate for each legitimate user is generated, and the personal certificate is issued and stored by means of the blockchain-based certificate system. The server then searches for whether a corresponding personal certificate is present in the blockchain-based certificate system according to user information, and the personal certificate indicates that the identity authentication is successful when the corresponding personal certificate is present in the blockchain-based certificate system.

In this embodiment, the user's certificate is issued, stored, and validated using a blockchain-based certificate system. In this embodiment, the use of the blockchain-based certificate system for user authentication ensures system security and enables two-way authentication during encryption.

On the basis of the content of the foregoing embodiment, in an alternative embodiment, the foregoing step 102 may be implemented in the following manner

validating, by the client, a server certificate by means of DNSSEC to authenticate the identity of the server.

In this embodiment, DNSSEC is implemented firstly for the domain name of the server; and a server certificate is generated for the server, and a corresponding TLSA record is generated according to the server dome name and server certificate, the TLSA record includes the server certificate; the TLSA record is issued on the DNS system of the server, and DNSSEC signature is implemented for the TLSA record. The client then searches for a TLSA record corresponding to the server, and performing DNSSEC validation, if the validation passes, it indicates that the server certificate is valid and the server identity authentication is successful.

In this embodiment, the TLSA record is employed to record the server certificate, and the DNS SEC mechanism is employed for verification; that is, in this embodiment, the TLSA record is employed as the identity document, which can implement secure and effective identity validation for each user, thereby guaranteeing system security from the source. In addition, in this embodiment, DNSSEC is employed to validate TLSA record, which reduces user's dependence on external trusted third-party CAs and enhances the security and transparency of the identity validation. The TLSA record is a record type in the DNS protocol, and is configured to validate certificates in the encrypted connection process of transport layer security protocol TLS.

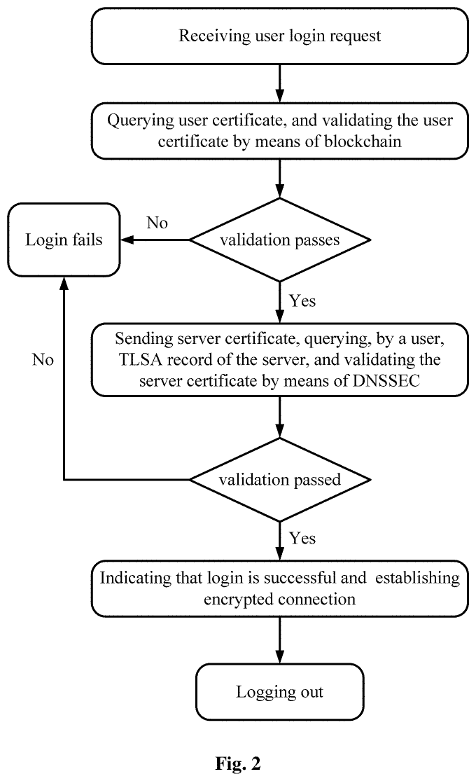

From the description above, in this embodiment, the blockchain and DNSSEC-based certificate validation mechanism enables two-way authentication of the connection process. The specific implementation process of the blockchain and DNSSEC-based user authentication method according to this embodiment will be described in more detail below in conjunction with the interaction flowchart shown in FIG. 2. As shown in FIG. 2, the blockchain and DNSSEC-based user authentication method according to this embodiment comprises the following steps:

step a: accepting a user's login request;

step b: searching for, by a server, a corresponding personal certificate in the blockchain-based certificate system according to the user information, and validating; indicating that the user certificate is invalid and the login fails when the validation fails;

step c: sending, by the server, the certificate to the client;

step d: searching for, by the client, a TLSA record corresponding to the management system of the server, and performing DNSSEC validation, indicating the server certificate is invalid and the login fails when the DNSSEC validation fails or the TLSA comparison is inconsistent;

step e: establishing an encrypted transmission connection when the certificates of both parties are successfully validated; and

step f: logging out after the business transaction is completed.

In this embodiment, the server certificate is employed to establish the TLSA record; and when the connection is initialized, the TLSA record is validated by means of the DNSSEC mechanism to confirm the identity of the server, and the identity of the user is queried and validated by means of the blockchain-based certificate system, by way of which the two-way authentication is achieved during the encrypted connection process, thereby greatly reducing the dependence on third-party credibility, and enhancing the reliability of security authentication.

It should be noted that through the blockchain and DNS SEC-based user authentication method according to this embodiment, the traditional authentication and protection mechanism is improved, and the whole process is simple and convenient, secure and reliable, highly operable and the problem of mutual authentication of users of the Internet encrypted connection system is solved.

Another embodiment of the present application provides a blockchain and DNSSEC-based user authentication system. Referring to FIG. 3, the system comprises: a client and a server; wherein:

the server is configured to authenticate the identity of the client by means of a blockchain-based authentication mechanism; and

the client is configured to authenticate the identity of the server by means of a DNS SEC-based mechanism.

Since the blockchain and DNSSEC-based user authentication system according to this embodiment can be employed to implement the blockchain and DNSSEC-based user authentication method described in the foregoing embodiments, working principles and beneficial effects thereof are similar, thus they are not described in detail herein, and details can be referred to the introduction of the foregoing embodiments.

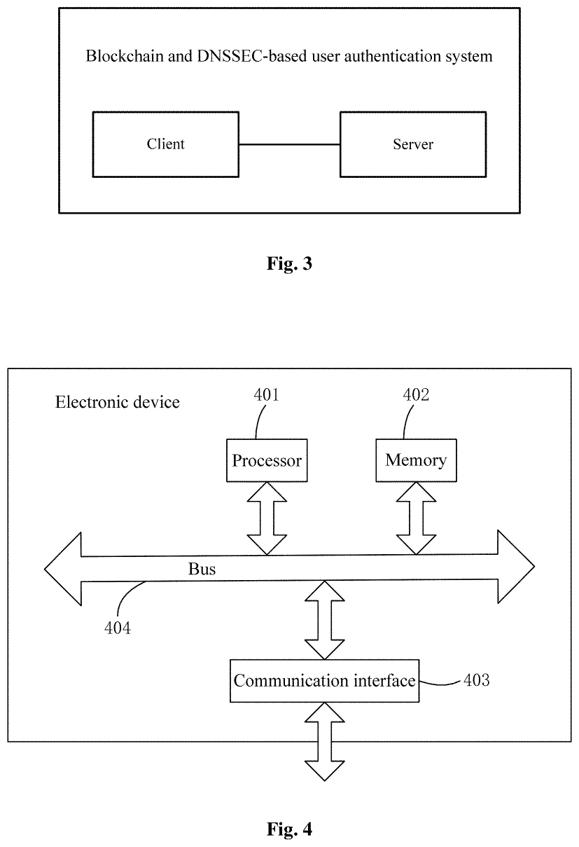

Yet another embodiment of the present application provides an electronic device. Referring to FIG. 4, the electronic device specifically comprises: a processor 401, a memory 402, a communication interface 403, and a bus 404.

The processor 401, the memory 402, and the communication interface 403 communicate with each other through the bus 404. The communication interface 403 is employed to enable the information transmission between each modeling software and related devices such as smart manufacturing equipment module libraries.

The processor 401 is employed to call a computer program in the memory 402. When the computer program is executed by the processor, all the forgoing steps of the blockchain and DNS SEC-based user authentication method are implemented. For example, when the computer program is executed by the processor, the following steps are implemented:

Step 101: when an encrypted connection over the Internet need to be performed between a server and a client, authenticating, by the server, the identity of the client by means of a blockchain-based authentication mechanism.

Step 102: when an encrypted connection over the Internet need to be performed between a server and a client, authenticating, by the client, the identity of the server by means of a DNSSEC-based mechanism.

Yet another embodiment of the present application provides a computer readable storage medium in which a computer program is stored, and the computer program is executable by the processor to implement all the foregoing steps of the blockchain and DNS SEC-based user authentication method. For example, when the computer program is executed by the processor, the following steps are implemented:

Step 101: when an encrypted connection over the Internet need to be performed between a server and a client, authenticating, by the server, the identity of the client by means of a blockchain-based authentication mechanism.

Step 102: when an encrypted connection over the Internet need to be performed between a server and a client, authenticating, by the client, the identity of the server by means of a DNSSEC-based mechanism.

In the description of the present application, it should be noted that, the orientation or positional relation indicated by the terms such as “upper,” “lower” is based on the orientation or positional relationship shown in the drawings, the purpose of which is only to facilitate the description of the present application and simplify the description, rather than to indicate or imply that the referred device or element must have a particular orientation, be constructed and operated in a specific orientation, and therefore should not be construed as a limitation of the embodiments of the present application. Unless otherwise clearly specified or defined, the terms “install,” “connect with” and “connect to” should be understood in a broad sense, for example, it can be a fixed connection or a detachable connection, or an integral connection; it can be mechanically connected or electrically connected; it can be directly connected or indirectly connected through an intermediary, and can be communication between interiors of two elements. For those of ordinary skill in the art, the specific meaning of the terms above in the present application can be understood according to the specific situations.

It should also be noted that, in the present application, relational terms such as first and second are only used to distinguish one entity or operation from another entity or operation, and do not necessarily require or imply any such actual relationship or order between these entities or operations. In addition, the terms “comprise,” “include,” or any other variants thereof are intended to cover non-exclusive inclusion, so that a process, method, article or device including a series of elements includes not only those elements, but also other elements that are not explicitly listed, or elements inherent to the process, method, article, or device. Without specific restrictions, the element defined by the sentence “comprising a . . . ” does not exclude the existence of other elements in the process, method, article, or device including the element.

In addition, the terms “first,” “second” and “third” are used for descriptive purpose only and should not be understood as indicating or implying the relative importance.

The embodiments are only for illustrating the technical solutions of the present application, rather than limiting them. Although the present application has been described in detail with reference to the foregoing embodiments, those skilled in the art should understand that the technical solutions documented in the preceding embodiments may still be modified, or parts of the technical features thereof can be equivalently substituted; and such modifications or substitutions do not deviate from scope of the technical solutions of the embodiments of the present application.

1. A blockchain and Domain Name System Security Extensions (DNSSEC)-based user authentication method, comprising:
in response to determining that an encrypted connection over Internet need to be performed between a server and a client, authenticating, by the server, an identity of the client by a blockchain-based authentication mechanism, and authenticating, by the client, the identity of the server by a DNSSEC-based mechanism.

2. The method of claim 1, wherein the authenticating, by the server, the identity of the client by a blockchain-based authentication mechanism comprises:
authenticating, by the server, the identity of the client according to a blockchain-based certificate system.

3. The method of claim 2, wherein the authenticating, by the server, the identity of the client according to a blockchain-based certificate system comprises:
searching for, by the server, whether a corresponding personal certificate is present in the blockchain-based certificate system according to user information, and indicating that the identity authentication is successful in response to determining that the corresponding personal certificate is present in the blockchain-based certificate system.

4. The method of claim 3, further comprising: before the authenticating, by the server, the identity of the client according to a blockchain-based certificate system,
establishing a blockchain-based certificate system, generating a personal certificate for each legitimate user, and issuing and storing the personal certificate by the blockchain-based certificate system.

5. The method of claim 1, wherein the authenticating, by the client, the identity of the server by a DNSSEC-based mechanism comprises:
validating, by the client, a server certificate by DNSSEC to authenticate the identity of the server.

6. The method of claim 5, wherein the validating, by the client, a server certificate by DNSSEC to authenticate the identity of the server comprises:
searching for, by the client, a transport layer security authentication (TLSA) record corresponding to the server, and performing DNSSEC validation, indicating that the identity authentication is successful in response to determining that the DNSSEC validation passes.

7. The method of claim 6, further comprising: before the validating, by the client, a server certificate by DNSSEC to authenticate the identity of the server implementing DNSSEC for a domain name of the server;
generating a server certificate for the server, and
generating a corresponding TLSA record according to the server certificate, the TLSA record including the server certificate.

8. A blockchain and DNSSEC-based user authentication system, comprising: a client and a server;
wherein the server is configured to authenticate an identity of the client by a blockchain-based authentication mechanism; and
the client is configured to authenticate the identity of the server by a DNSSEC-based mechanism.

9. An electronic device, comprising: a memory, a processor, and a computer program stored in the memory and executable by the processor, wherein the processor is configured to execute the program to implement the steps of the blockchain and DNSSEC-based user authentication method of claims 1-7.

10. A computer readable storage medium storing a computer program, wherein the computer program is executable by a processor to implement the steps of the blockchain and DNSSEC-based user authentication method of claims 1-7.
